(19) United States
(12) Patent Application Publication
(10) Pub. No.: US 2022/0043546 A1
(43) Pub. Date: Feb. 10, 2022

(54) SELECTIVE SERVER-SIDE RENDERING OF SCRIPTED WEB PAGE INTERACTIVITY ELEMENTS

(71) Applicant: 360 IT, UAB, Vilnius (LT)

(72) Inventors: Dmitrijus GLEZERIS, Vilnius (LT); Indre ZEMLERYTE, Vilnius (LT)

(21) Appl. No.: 16/986,095

(22) Filed: Aug. 5, 2020

(51) Int. Cl. G06F 3/0484; G06F 40/143

(52) U.S. Cl. CPC G06F 3/0484; G06F 40/143

(57) ABSTRACT

The present application relates to a computer having a processor configured to execute a set of instructions to render a customized version of a document object model with part of the content rendered being User Interface elements. A scripted UI element in a document object model is identified and at least one rule associated with the UI elements is accessed. The at least one rule is applied to the scripted UI element to generate a modified document object model which is then rendered server-side. The present application relates to server-side rendering techniques in Web content delivery; content filtering based on user-specific and context-based requirements; and efficiency techniques.

### FIELD

This disclosure relates to a computer configured to perform dynamic server-side rendering of a document object model, comprising, among others, the dynamically rendered user interface interaction elements of a web application. Aspects of the invention relate to a computer, a machine-readable storage medium and a related method.

### BACKGROUND

It is increasingly common to utilize Web resources to provide rich interactive applications. These applications are accessed over the Internet and are presented as Web pages with the elements of interactivity. The page may also dynamically present data obtained from external sources during the actual load of the application page. Accordingly, there is an increasing need for effective control over the way the interaction elements and application content, scripted within a web page, are delivered, rendered and presented to the end user.

It is against this background that the present invention has been conceived. Embodiments of the invention may provide a computer, a machine-readable storage medium and a related method which overcome or mitigate one or more of the shortcomings of known systems.

The proposed solution provides an effective way to ensure quicker user-side content demonstration within the user's browser session, helps avoid same-session user-side reiterated rendering of the content due to additional data delivered through external API calls, and helps achieve better search engine optimization (SEO) rate.

The following sections will elaborate and clarify the technology notions the solution employs, is dependent upon or is related to.

The conventional method for getting the HTML content presented on a user's screen was by using server-side rendering. Server-side rendering was especially effective since historically web pages were mostly presenting static images and text, with little inroads into interactivity.

To elaborate, server-side rendering has long been the most common method for displaying static information onto the screen. It works by converting HTML files in the server into usable information for the browser.

Whenever a user visits a website, the browser makes a request to the server that contains the contents of the website. The time it takes to service the corresponding request ultimately depends on a multitude of factors:

The speed of the Internet connection of the user;

the geo location of the server; i.e. the distance between the user and the server; technically the latency for the network connection;

the physical load that the concurrent user sessions present for the server;

the level of optimization the website has been subjected to, among others.

Once the request has been fully processed by the server, the user's browser receives the fully rendered HTML content and displays it on the screen. This happens for every new request the user might initiate to this or other web sites, thus introducing delays in preparing and displaying the content to the user.

Server-side rendering is effective for optimizing the content for indexing by search engines (SEO). Since the content is fully rendered when requested, search engines are able to crawl and index it at once completely.

However, the current Web landscape has very much changed with dynamic and richly scripted content delivered within the framework of traditional websites. Interactive content within Web pages is currently very much a mainstream resource that can be used to send messages, update online information, shop; and more; with the interactive elements delivered via web browsing scripted for execution and rendering within the context of the end-user computing device i.e., on the client side.

Client-side rendering is an alternative way of executing the scripted components of a web page within the browser context of the user's computing device, using JavaScript. Therefore, the content of the HTML document contains the code to be executed, with the finalized page rendered and demonstrated to the User after the scripted part has been executed by the JavaScript engine of the users computer. As a consequence, the parts of the document that require additional data not available within the original HTML code can be rendered with the help of the scripted components without processing the whole document.

Modern websites present a rich interactive experience requiring complex programming with the results of executing hundreds of lines of code influencing the presentation of the static content, as well as the interactive elements, such as User Interface elements e.g. buttons to press, items to choose from lists and the like.

The primary trade off with using client-side rendering is that since the content is not rendered until the page is loaded on the browser, SEO for the website will not reach its full potential.

Also, the corresponding website or application may not be able to load fully until all of the JavaScript is downloaded to the browser. Depending on the link speed available to the User, the load time for the page may increase considerably.

The availability of the full content for crawling and indexing by the search engines, fast initial page load and effective rendering of static content are benefits of the server-side rendering, while bigger server processing load and the necessity of fully reloading the page in the event any element of the page needs reloading are drawbacks of the said methodology.

Multiple benefits of the client-side rendering option helped ensure its ubiquitous utilization in Web resource development, such as rich site interactions, fast website rendering after the initial load, to name but a few.

Several problems with the client-side content rendering mechanism exist. For example, search engines typically do not execute scripts. Therefore, when the search engine queries the Web server for a web page, the search engine obtains what static HTML code and possibly a templating engine provide, i.e., the web page layout information and static content. Search engines cannot retrieve the actual content that is necessary for indexing the relevant data if the search engine is required to execute the scripted parts of the document.

In addition, a user's web browser may not have script execution capability, or the script execution capability may be disabled as a security precaution. As a result, the user's web browser cannot execute the scripts within the requested web page, and therefore cannot render the content of the corresponding web page and fully present it to the user.

Another client-side rendering artefact is so-called “flickering”, which is the delayed, or otherwise displaced time-wise, execution of scripted properties assigned to elements of the page. One of the possible causes is the asynchronous execution of the scripts within the page and simultaneous loading of other multiple elements within the Document Object Model. Since the updated versions of the dynamic elements are applied to the rendered version of the document as the page is being loaded, objects within the rendered version may be misplaced, overlap with each other or randomly move during the loading of the page.

Although specific shortcomings of existing systems have been demonstrated and described in the background art, those skilled in the art will understand that the claimed components are not limited to a particular implementation that solves any or all of the shortcomings described.

A web template system in web publishing lets web designers and developers work with web templates to automatically generate custom web pages, such as the results from a search. This reuses static web page elements while defining dynamic elements based on web request parameters. Web templates support static content, providing basic structure and appearance. Developers can implement templates from content management systems, web application frameworks, and HTML editors.

A web template system comprises:

A template engine: the primary processing element of the system;

Content resource: any of various kinds of input data streams, such as from a relational database, XML files, LDAP directory, and other kinds of local or networked data;

Template resource: web templates specified according to a template language;

Generated output in the form of result documents. These may consist of an entire document or a document fragment.

The template and content resources are processed and combined by the template engine to produce web documents. For the purposes of this application, web documents include any of various output formats for transmission over the web via HTTP, or another Internet protocol.

A web browser and web server employ a client-server architecture. Sites may also use web caching capabilities to improve performance i.e., storing the most often accessed content in a quick-access storage in an already-rendered format. Several templating system types are classified based on when they replace placeholders with real content and assemble pages.

Server-side—run-time substitution happens on the web server

Client-side—run-time substitution happens in the web browser

Edge-side—run-time substitution happens on a proxy between web server and browser

Outside server—static web pages are produced offline and uploaded to the web server; no run-time substitution

Distributed—run-time substitution happens on multiple servers

For the purpose of the presently described systems, computer program products and methods focus will be on the first two types.

A template processor (also known as a template engine or template parser) is software designed to combine templates with a data model to produce result documents. The language that the templates are written in is known as a template language or templating language. For purposes of the current application, a result document is any kind of formatted output, including documents, web pages, or source code (in source code generation), either in whole or in fragments. A template engine is ordinarily included as a part of a web template system or application framework, and may be used also as a preprocessor or filter.

The Document Object Model (DOM) is a programming interface for HTML and XML documents. It represents the page so that programs can change the document structure, style, and content. The DOM represents the document in a tree-like structure, as nodes and objects, with their unique distinctive identificators. That way, programming languages can connect to the page and the elements within t,

A web page, as a document, can be either displayed in the browser window or as the HTML source. The DOM represents that same document so it can be manipulated. The DOM is an object-oriented representation of the web page, which can be modified with a scripting language such as JavaScript.

When a web page is loaded, the browser creates a DOM of the page, which is an object oriented representation of an HTML document that acts as an interface between Java Script and the document itself. This allows the creation of dynamic web pages, because within a page JavaScript can add, change, and remove any of the HTML elements and attributes, change any of the CSS styles, react to all the existing events and create new events.

The W3C DOM and WHATWG DOM standards are implemented in most modern browsers. Many browsers extend the standard, so care must be exercised when using them on the web where documents may be accessed by various browsers with different DOMs.

All of the properties, methods, and events available for manipulating and creating web pages are organized into objects (for example, the document object that represents the document itself, the table object that implements the special HTMLTableElement DOM interface for accessing HTML tables, and so forth).

The modern DOM is built using multiple APIs that work together. The core DOM defines the objects that fundamentally describe a document and the objects within it. This is expanded upon as needed by other APIs that add new features and capabilities to the DOM. For example, the HTML DOM API adds support for representing HTML documents to the core DOM.

The DOM was designed to be independent of any particular programming language, making the structural representation of the document available from a single, consistent API. While the embodiments of the present disclosure leverage JavaScript, implementations of the DOM can be built for any language.

In computer science, an interpreter is a computer program that directly executes instructions written in a programming or scripting language, without requiring previously compiling into a machine language program.

A scripting engine is an interpreter that turns script source code, directed at performing certain tasks, into machine code on the fly i.e., at the execution time. In interpreter (or scripting engine) is the component that is responsible for loading said source code of a script and turning it into machine code at execution time (as opposed to a compiler which creates machine code prior to execution time), and ultimately running it as a set of machine instructions for a system, or application to perform.

### SUMMARY

To mitigate the problems associated with the standards of executing and rendering the scripted interactivity elements within the context of a user's browser, a web server can identify one or more scripted interactive User Interface elements in a web page HTML source code and execute said scripted elements within the web server's scripting engine to render the requested page including the scripted elements and present the user with the modified document object model. The appearance of the document object model can be modified, for example, to place the graphical elements associated with the scripted interactive User Interface elements within the page. The structure of the document object model can be modified, for example to place the data, or the visual presentation of the data, within the page.

The methods described herein can be computer-implemented. The methods can be performed by a computer comprising one or more electronic processors configured to perform a set of instructions. The set of instructions can be implemented in hardware or software. The software can be provided in a computer-readable medium or downloaded over a network, such as the internet.

Many of the attendant features of the present invention will be more readily appreciated and understood by reference to the following detailed description of a preferred embodiment considered in connection with the accompanying drawings.

### DESCRIPTION OF DIAGRAMS

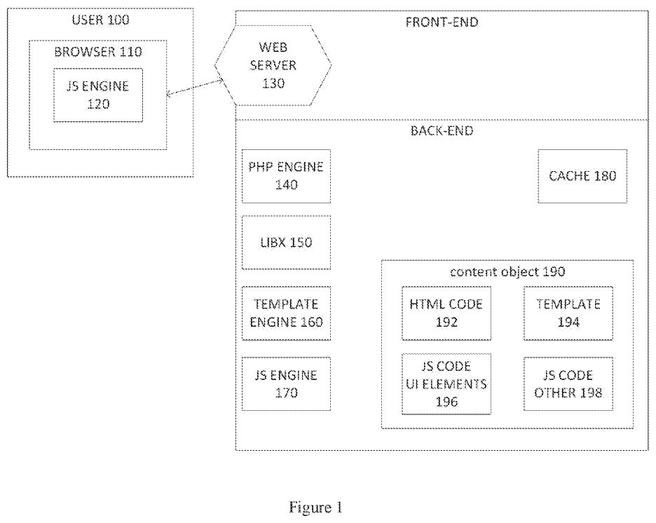

FIG. 1 is a block diagram of a platform providing web content containing both static and dynamic content, including scripted elements, according to the embodiments.

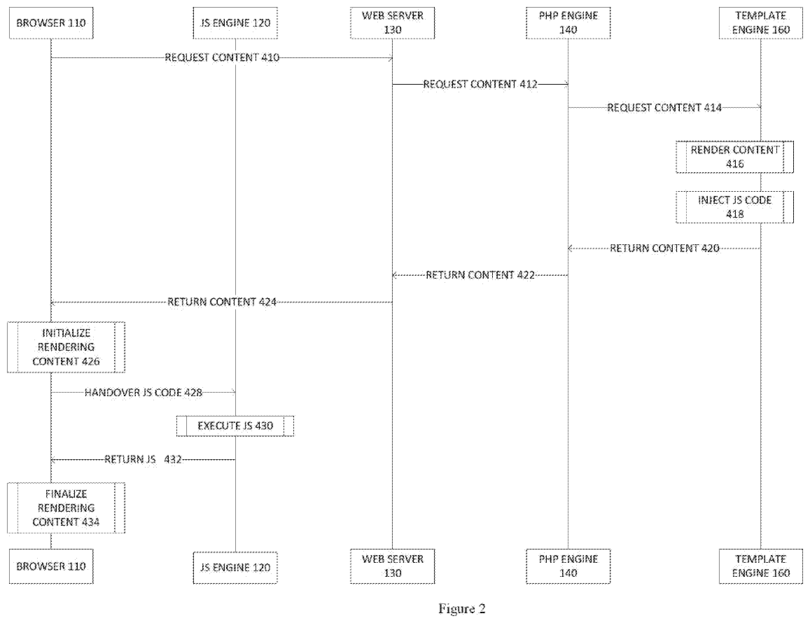

FIG. 2 is a flow diagram demonstrating a client-side rendering of scripted elements within a web page according to the embodiments.

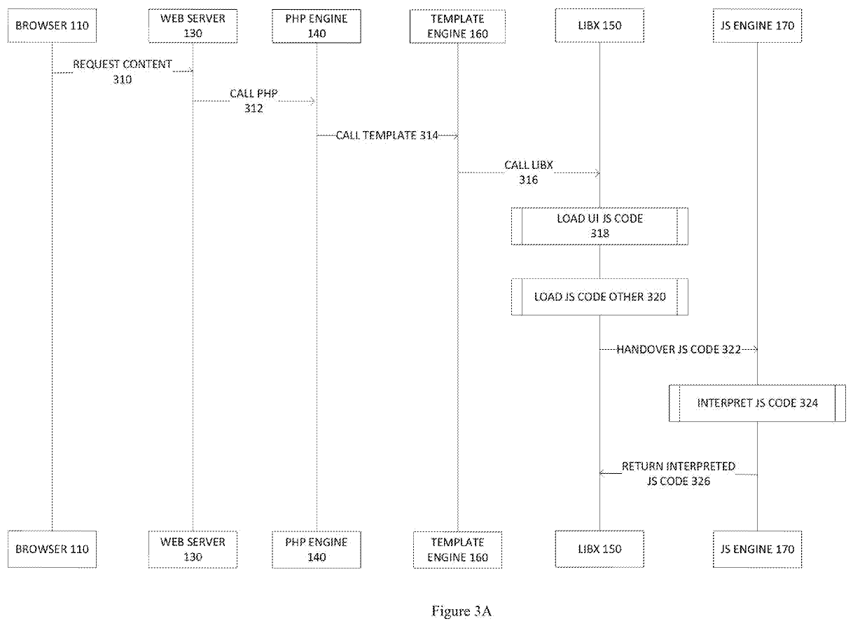

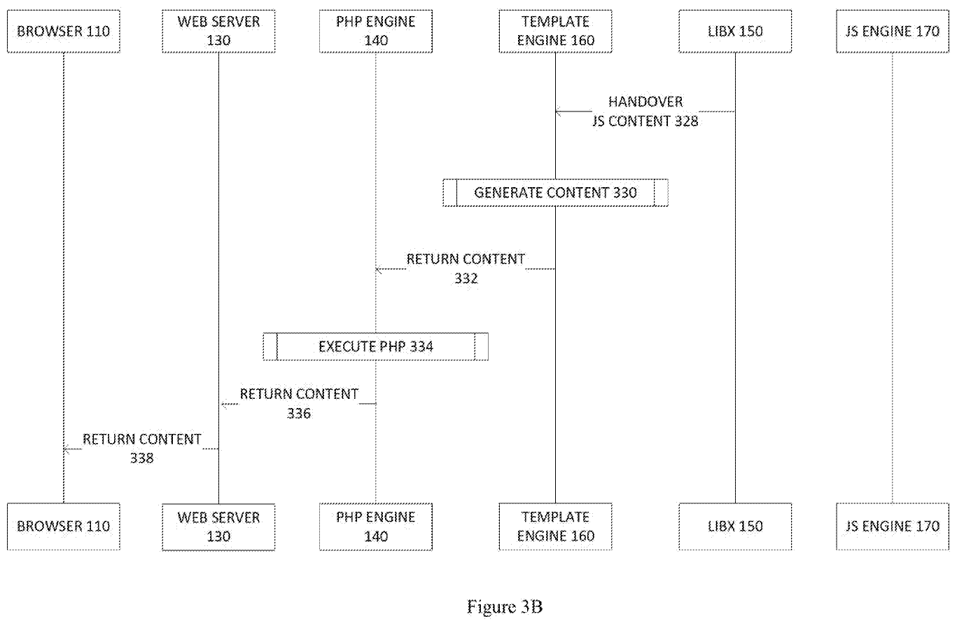

FIG. 3A is a flow diagram illustrating a server-side rendering of an initial content of a web page according to the embodiments.

FIG. 3B is a continuation flow diagram illustrating a server-side rendering of the initial content of a web page according to the embodiments.

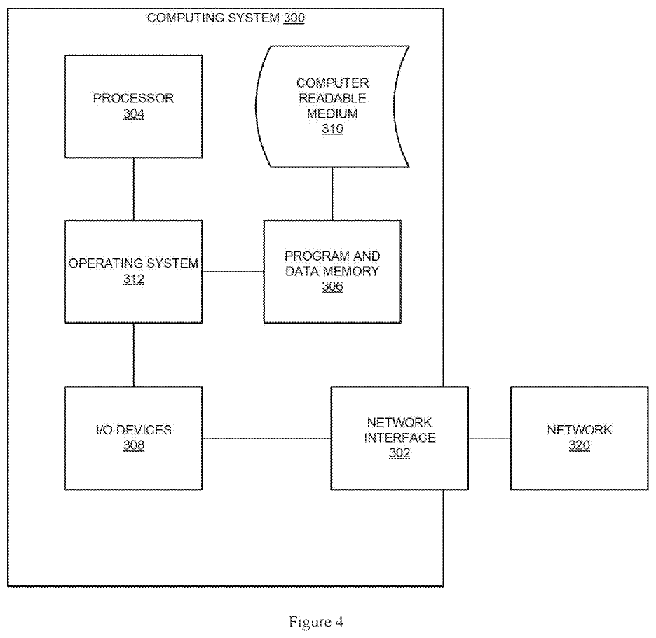

FIG. 4 is a block diagram illustrating a computer system for a web server performing server-side rendering of initial content of a web page according to the embodiments.

### DETAILED DESCRIPTION

Some general terminology descriptions may be helpful and are included herein for convenience and are intended to be interpreted in the broadest possible interpretation.

User 100—a computing device user that can access and request content from the Web server, usually in the format of a Web page. This interaction takes place with the help of a browser, launched locally within the computing device of the User, or an alternative type of application with similar functionality.

Web Server 130—a computing device that can store, process and present the content to the audience through HTTP protocol. The content serviced in that fashion can be documents in HTML format that may be combined with the elements of interactive functionality.

LibX 150—the integration functionality between the multiple components of the web server that specifically serves for managing the interaction elements within the content delivered by the Web server to be executed and rendered server-side before being presented to the User's browser.

Content Object 190—a document object delivered by a web server, comprising the rendered HTML code defining the layout and possibly including the static and dynamic content, as well as the results of executing the scripted elements within the document.

Template 194—a reusable element employed by the templating engine within a web server for generating web pages that combine the dynamic parts representing the data that is different across multiple pages and the actual template, i.e., the static uniform part, usually the static content providing the structure and appearance of the web page.

JS code UI 196—the elements within the web document that represent the scripted interactive User Interface components.

JS code other 198—the elements within the web document that represent scripted objects other than User Interface interactive elements.

In summary, a server in a distributed computing system can provide the initial content of a web page, usually rendered by a client-side script, according to aspects of the present invention. Accordingly, the client can display the initial content of the web page even when the client's web browser cannot execute the client-side script to generate the initial content. As a result, search engines that generally do not execute scripts can obtain the initial content of a web page for indexing.

The foregoing aspects and many of the attendant advantages of the present invention can be more readily and better understood with reference to the following detailed description taken in conjunction with the drawings in which the following, exemplary embodiments of the invention are shown and described. However, one of ordinary skill in the art appreciates that various modifications can be made thereto without departing from the spirit and scope of the invention.

Embodiments of the invention can be described in the general context of computer-executable instructions, such as program modules, being executed by a computer including at least a processor and memory. Generally described, program modules include routines, programs, widgets, objects, components, data structures, etc. that perform particular tasks or implement particular abstract data types. Embodiments of the invention can also be implemented in distributed computing systems that include multiple entities. Some of the entities have a possibility of functioning as a server that provides a service, and some have a possibility of functioning as a client that receives a service provided by the server e.g., a web page. Entities can be collocated within the same computer system or be distributed across distinct computing devices communicating remotely through a communications network. In a distributed computing system, program modules can be located in local and/or remote computer storage media.

In a distributed computing system that includes multiple entities, such as a client component (“User”) and a server component (“Web Server”), the Web Server typically serves the client with web pages that can comprise the static layout and data, as well as the scripted elements that provide for the dynamic content or interaction functionality. The client executes the script, or multiple scripts, to render the scripted elements. That is, after the initial content of the web page is rendered by the client side script, the content of the web page is subsequently re-rendered by the client side script in response to user actions and input from other entities in the distributed computing system.

One aspect of the invention includes a distributed computing system that includes at least one server and at least one client. The server provides one or more web pages for the client to display. Web Server 130 uses an internal JS Engine 170 to render a file containing web page source code. In some embodiments the file mentioned above can be an HTML file incorporating scripted elements that must have their source code executed by a script engine in order to be rendered. The Web Server can further include a script engine (“server-side script engine”) that performs the executing and rendering function similar to the script engine used by the Browser 110 at the computing device of User 100.

Aspects of the present invention relate to a computer, a machine-readable storage medium and a method.

According to a first aspect of the present invention, there is provided a computer comprising:

a processor configured to execute instructions;

instructions that, when executed by the processor, direct the computer to perform operations to render a customised version of a document object model, the operations comprising:

identifying an interactive User Interface element scripted for client-side execution, in an instance of a document object model;

accessing at least one rule associated with classifying the User 100 that requested the content comprising the scripted interactive user interface element as requiring server-side execution and rendering of the content requested;

applying one, or multiple, rules to said User 100's request to provide for executing and rendering scripted interactive user interface element server-side to generate a modified document object model; and

accessing a server-side scripting engine;

executing scripted interactive User Interface element, or multiple elements, to generate a modified document object model;

rendering, server-side, said modified document object model;

presenting the rendered modified document object model to the user's browser.

The Web Server can identify one or more scripted interactive User Interface elements in a document object model and execute said scripted elements to modify the document object model before presenting the document to the user. The appearance of the document object model can be modified, for example to place the graphical elements associated with the scripted interactive User Interface elements within the page. The structure of the document object model can be modified, for example to place the data, or the visual presentation of the data, within the page.

The document object model can comprise a plurality of elements. One or more of said elements in the document object model can be classified as being scripted interactive objects that are to be executed client-side, i.e., within the context of the requesting user's browser. The step of executing the scripted objects associated with said interactive elements can comprise executing and rendering at least one of said scripted interactive user interface elements server-side before presenting it to the requesting user. Some or all of the elements within the document object model can be executed and rendered.

The document object model can be a part of a web page. One or more of the document object models making up a web page can be classified as being interactive. The rendered version of the web page can comprise at least one modified document object model and optionally at least one unmodified document object model.

Alternatively, the document object model can define a complete web page. The document object model can be identified as being interactive if the web page is interactive.

The step of identifying a document object model enriched with interaction functionality can comprise looking up an identifier, such as a script tag, within the source code for the page, or a call to a UI-constructing function. Upon receipt of a navigation request, the URL of the requested content object can be subjected to script tag or function call look-up. The step of identifying the interactive elements scripted for client-side execution and rendering, and executing said elements server-side before presenting the resultant page to the user may be followed by performing at least single check against the table of rules defined for processing the scripted elements of the content requested server-side depending on identifying a particular attribute of User 100, such as geo-location (determined from an active ip address); class, or capacity, of rendering device (for example, smartphone, computer etc.), etc.

The operations can include the step of determining whether one or more of said rules is applicable. This step can be repeated for each scripted interactive user interface element within the document object model. If one or more of said rules is not applicable to a User 100 requesting content the, the operations can comprise rendering the document object model in an unmodified form.

Alternatively, or in addition, the operations can comprise identifying contextual data and applying a rule, or multiple rules, of executing and rendering scripted UI elements server-side based on said contextual data. The contextual data can include one or more of the following:

the geographical location of a user, employing a web browser to access the web page or a web application over said network;

the type of device used to access the application over the network;

the type of connection used to access the application over the network; and

temporal restrictions, for example based on the Web Server processing power utilization threshold.

The rules can be defined, stored and obtained from a database. The database can be located on the Web Server or on a remote server.

The steps of applying the rules and modifying said document object model can be performed as said first document object model is loading, rather than after it has loaded. The modified document object model can be rendered without previously having rendered the (unmodified) document object model. Thus, the source document object model is not rendered. This approach can help to avoid flickering which may otherwise occur when an element is displayed and then removed or changed dynamically. A plurality of document object models can be modified and the modified document object models rendered simultaneously.

In a further aspect of the present invention there is provided a machine-readable storage medium having machine-executable instructions encoded thereon that upon execution by a processor direct a computer to perform operations comprising:

identifying an interactive User Interface element scripted for client-side execution, in an instance of a document object model;

accessing at least one rule, within the storage designated for containing such rules, defined for the classifying of users requesting the content from the Web server regarding the choice of executing and rendering the scripted interactive user interface element server-side;

applying one, or multiple, rules to matching user's request to generate a modified document object model; and

accessing a server-side scripting engine;

executing scripted interactive User Interface element to generate a modified document object model;

rendering, server-side, said modified document object model;

presenting the rendered modified document object model to the user's browser.

The operations can further comprise the step of determining which of said rules is applicable to said classified user. The steps of applying a rule, or multiple rules, and rendering said modified element can be repeated for a plurality of document object models.

In a still further aspect of the present invention there is provided a method of rendering a customized version of a document object model enriched with scripted interactivity elements, the method comprising:

identifying an interactive User Interface element scripted for client-side execution, in an instance of a document object model;

accessing at least one rule defined for classifying users requesting the content from the Web server scripted regarding the choice of executing and rendering the scripted interactive user interface element server-side;

applying at least one rule to said classified users' request regarding generating a modified document object model; and

accessing a server-side scripting engine;

executing scripted interactive User Interface element to generate a modified document object model;

rendering, server-side, said modified document object model;

presenting the rendered modified document object model to the user's browser.

The document object model can form a part of a web page, or a complete web page.

FIG. 1 illustrates an exemplary distributed computing system that includes at least one User 100 and at least one Web server 130, wherein User 100 is further supported by Browser 110 and JS Engine 120, while Web server 130 is further dissected into PHP Engine 140, LibX 150, Template Engine 160, JS Engine 170 and Cache 180. The primary deliverable of the Web server 130 to the User 100 is the Content Object 190, or alternatively the full document object model, resultant of the rendering HTML code 192, Template 194, as well as executing JS code for UI-related scripted elements 196 and JS code for non-UI scripted elements 198.

FIG. 2 demonstrates as, responsive to a standard request from a User 100 via Browser 110, Web server 130 presents the resultant Web page, rendered by the corresponding assisting functionalities e.g. PHP engine 140 and Template Engine 160, whereas the resultant HTML transferred to the user for presenting of the rendered part of the Web page, and the JavaScript code that is present within the Web page is transferred to the Browser 110 for further processing by the JavaScript Engine 120 within the computing device of the User 100. The model demonstrated in FIG. 2 is the standard way to render the interactive scripted elements.

As depicted in FIG. 3A, when a request 310 for displaying a web page is received from the client 100 via Browser 110, the Web server 130 identifies the files that need to be processed for producing the resultant Web page, collects the relevant request data e.g. request URL, technical request headers and may pass some or all of the info collected in step 312, passing the at least the request URL to to PHP Engine 140.

While processing the request from Web Server 130, PHP Engine 140 passes the request to the Template engine 160 in step 314, identifying the template file (Template 194) to be used for producing the Web page (Content object 190) and providing the path to it.

While processing the request received Template engine 160 determines the presence of the scripted interactivity elements within the requested content by identifying the calls to functions related to LibraryX 150, and in step 316 forwards the request to the innovative instrumentality LibraryX 150, passing alongside the information deemed relevant for processing the request e.g. the technical headers and variables contained within the request passed during the step 312.

In steps 318-320 the innovative instrumentality LibraryX 150 loads the scripted elements 196 and 198 identified within the Template 194 and in step 322 forwards said elements to JavaScript Engine 170, which in step 324 interprets the JavaScript code provided in step 322, and in step 326 returns the interpreted JavaScript code.

Step 328 refers to the LibraryX 150 returning the results of steps 318-326 to Template engine 160, which in step 330 combines the data provided with Template 194, coupled with CCS components, external JS script files 196 and 198 and PHP instructions, if present within the page, that should be executed before presenting the Web page to the User 100, e.g. calls to external systems for additional data.

As further shown in FIG. 3A, the activity of step 332 comprises passing the result of step 320 to the PHP engine 140 for further execution (step 324) of PHP instructions embedded within the content generated (Content Object 190).

FIG. 3B further demonstrates step 336 that combines and transfers to Web Server 130 the HTML code of Content object 190 coupled with the CSS component and the JavaScript files 196 and 198.

Step 338 describes the returning of the Web page content, to the Browser 110.

This summary is provided to introduce a selection of concepts in a simplified form that are further described below. This summary is not intended to identify key features of the claimed components, nor is it intended to be used as an aid in determining the scope of the claimed components.

Aspects of the invention solve the problems identified above by executing on the server a client-side script, or scripts, that renders the initial content of the web page. When executed, the script, or scripts, creates a client side execution environment on the server for generating the initial content of the web page. As a result, the initial rendering of the web page sent by the server to the client already contains the full initial content, including the scripted interactivity elements.

FIG. 3A and FIG. 3B show an exemplary implementation of a server-side script execution process that renders an initial page such as Content Object (190) for a web page. The initial page has all the initial content of the web page. As shown in FIG. 3, the Web Server 130 begins with a conventional initial rendering, i.e., the provision of HTML code (192) that may be integrated with Template 194, delivered and processed by Template Engine 160, and through this combination includes web page layout information as well as static information. Further on, source code for JS scripts may be embedded in the resultant HTML code either directly or as a reference. In addition to preparing web page layout information and static content, Web server 130 executes script 196 and script 198 for the web page. Since the script 196 and script 198 are designed to be executed within the context of Browser 110 by JS engine 120 at the computing device of User 100, the scripts are also referred to as client-side scripts. In the exemplary embodiment of the invention, Web Server 130 scans the source code for HTML 192 for <script> tag and <script src= . . . > and builds the scripts by fetching or interpreting the script. In an exemplary embodiment of the invention, the script 196 is executed in a rich execution environment.

In embodiments of the present invention, Web Server 130 and its components may be located on the same computer or on various computers within distributed computer system 300. FIG. 4 illustrates an exemplary computer system 300 for Web Server 130 that is suitable for implementing aspects of the invention. Web Server 130 connects to the network 320 using the network interface 302. Network interface 302 includes hardware and software that allows Web Server 130 and other computing devices connected to the network 302 using one or more suitable communication protocols, such as the TCP/IP protocol. It is essential to be able to communicate. For example, since User 100 resides on another computer system and can only be communicated with through network connectivity, Web Server 130 communicates with User 100 through network interface 302.

Web Server 130 further includes a processor 304, a memory 306, and an input/output interface 308. Processor 304 is configured to operate according to computer program instructions stored in a memory such as memory 306. The program instructions can also be embodied in a hardware form such as a programmable digital signal processor.

Memory 306 can comprise any type of storage device and can include, for example, RAM, ROM, and/or removable computer readable media. Memory 306 can store operating system 312 that controls the operation of Web Server 130. The operating system 312 can be a general purpose operating system such as, for example, a Microsoft® server operating system, UNIX®, or LINUX.

As described above, in the exemplary embodiment of the invention, Web Server 130 builds an environment for executing client-side JS script 196 and JS script 198 that generate at least a portion of the initial content of a web page. The environment of Web Server 130 can further include a server-side script engine 170 that functions similarly to script engine 120 used by User 100. Therefore, as shown in FIG. 4, the memory 306 of the Web Server 130 further stores program codes and data that provide the server-side script engine 170. The source code of the JS scripts 196 and 198 includes computer-executable instructions that, when executed by the processor 304, produce an object model provided by a file such as HTML that contains web page source code. Server-side script engine 170 includes computer-executable instructions that when executed by processor 304 simulate or operate similar to the script engine used by User 100.

For simplicity of illustration, FIG. 4 does not show other common components such as a video display adapter, power supply, computer monitor, and the like. However, those skilled in the art will recognize that a wide selection of commercially available components that can be used to construct and operate a computer system as shown in FIG. 4

Although aspects of the invention have been described in language specific to structural features and/or methodological operations, it should be understood that the subject matter defined in the claims is not necessarily limited to the specific features or operations described above. Rather, the specific features and acts described above are disclosed as example forms of implementing the claims.

1. A computer implemented method for server-side rendering techniques in web content delivery, comprising:
identifying on a server-side an interactive User Interface element scripted for client-side execution, in an instance of a document object model;
accessing at least one rule defined for classifying users requesting the web content based on at least one network parameter from the Web server scripted regarding a choice of executing and rendering a scripted interactive user interface element server-side;
applying at least one rule to classified users' request regarding generating a modified document object model;
accessing a server-side scripting engine;
executing, by the accessed server-side scripting engine, the scripted interactive User Interface element to generate a modified document object model;
rendering, server-side, said modified document object model; and
presenting the rendered modified document object model to the user's browser.

2. The method of claim 1, wherein the document object model further comprises a plurality of elements, where one or more of the plurality of elements is classified as a scripted interactive object executed client-side.

3. The method of claim 1, wherein the step of identifying an interactive user interface element scripted for client-side execution, in an instance of a document object model further comprises applying rules for identifying at least one of:
an identifier, such as a script tag, within source code for a web page; and
a call to a User Interface-constructing function.

4. The method of claim 1, wherein the step of classifying the user as subject to the server-side rendering of scripted interactive elements comprises evaluating against rule set based on at least one of:
a geographical location of a user;
a class or capacity of a rendering device;
a type of device used to access the application over the network;
a type of connection used to access an application over the network; and
a temporal restriction based on a Web server processing power utilization threshold.

5. The method of claim 3, wherein the at least one rule is applied to a complete document object model.

6. The method of claim 3, wherein the steps of applying the at least one rule and rendering the first modified scripted interactive User Interface element of the document object model are repeated for each element of the document object model to which one or more of said rules is determined as being applicable.

7. The method of claim 3, further comprising rendering the document object model in an unmodified form if the at least one rule of identifying a user as subject to the server-side rendering of scripted interactive User Interface elements is not applicable to at least one scripted element within the document object model.

8. The method of claim 1, wherein the presenting the rendered modified document object model to the user's browser presenting the rendered modified document object model comprises at least one of:
the modified document object model;
an unmodified document object model; and
a document object model defining a complete web page.

9. The method of claim 1, wherein the step of executing the scripted objects associated with the scripted interactive elements further comprises executing and rendering at least one of said scripted interactive User Interface elements server-side before presenting it to a requesting user.

10. A computer program product embodied on a non-transitory computer readable storage medium for server-side rendering techniques in web content delivery, comprising:
computer code for identifying on a server-side an interactive User Interface element scripted for client-side execution, in an instance of a document object model;
computer code for accessing at least one rule defined for classifying users requesting the scripted web content from the Web server regarding a choice of executing and rendering a scripted interactive user interface element server-side;
computer code for applying at least one rule to classified users' request regarding generating a modified document object model;
computer code for accessing a server-side scripting engine;
computer code for executing, by the accessed server-side scripting engine, the scripted interactive User Interface element to generate a modified document object model;
computer code for rendering, server-side, said modified document object model; and
computer code for presenting the rendered modified document object model to the user's browser.

11. The computer program product of claim 10, wherein the document object model further comprises a plurality of elements, where one or more of the plurality of elements is classified as a scripted interactive object executed client-side.

12. The computer program product of claim 10, further comprising computer code for identifying a scripted interactive User Interface element within an instance of a document object model, comprising:
an identifier, such as a script tag, embedded within source code of a web page; and
a call to a User Interface-constructing function, placed within the source code of the web page.

13. The computer program product of claim 10, wherein the step of classifying users requesting the scripted content from the Web server as subject to executing and rendering the scripted interactive user interface element server-side comprises evaluating at least one of the following user's attributes:
a geographical location of a user;
a class or capacity of a rendering device;
a type of device used to access an application over a network;
a type of connection used to access the application over the network; and
a temporal restriction based on a web server processing power utilization threshold.

14. The computer program product of claim 13, wherein the at least one evaluation results in applying modification to a complete document object model.

15. The computer program product of claim 13, wherein the steps of evaluating and applying the at least one rule of classifying user as subject to server-side execution of scripted elements, and rendering the first modified element of the document object model are repeated for each element of the document object model to which one or more of said rules is determined as being applicable.

16. The computer program product of claim 12, further comprising rendering the document object model in an unmodified form if the at least one scripted interactive User Interface element is not identified within the document object model.

17. The computer program product of claim 13, further comprising rendering the document object model in an unmodified form if the at least one rule for classifying the requesting user as subject to server-side execution of scripted interactivity User Interface elements does not match upon evaluation.

18. The computer program product of claim 10, wherein the presenting of the rendered modified document object model to the user's browser comprises:
at least one of:
the modified document object model;
an unmodified document object model; and
a document object model defining a complete web page.

19. The computer program product of claim 10, wherein the step of executing the scripted objects associated with the scripted interactive User Interface elements further comprises executing and rendering at least one of said scripted interactive User Interface elements server-side before presenting it to a requesting user.
